(19) United States
(12) Patent Application Publication
(10) Pub. No.: US 2018/0088445 A1
(43) Pub. Date: Mar. 29, 2018

(54) Cell Phone Case with Extendable Remote Camera Control

(71) Applicants: Wilfred Robert Michaud, Orangeville (CA); Craig Holmes, Toronto (CA); Brian Johnston, Toronto (CA); Stephen Myska, Markham (CA); TMS Innovations Inc., Mississauga (CA)

(72) Inventors: Wilfrid Robert Michaud, Orangeville (CA); Craig Holmes, Toronto (CA); Brian Johnston, Etobicoke (CA); Graham N. Beck, Toronto (CA); Stephen Myska, Markham (CA)

(21) Appl. No.: 15/566,115

(22) PCT Filed: Apr. 13, 2016
(86) PCT No.: PCT/IB2016/000623

§ 371 Date: Oct. 12, 2017

Related U.S. Application Data
(60) Provisional application No. 62/146,863, filed on Apr. 13, 2015.

(51) Int. Cl. G03B 17/56; F16M 11/26; G03B 17/38; H04W 4/00

(52) U.S. Cl. CPC G03B 17/563; F16M 11/26; H04M 2250/52; H04W 4/008; G03B 17/38

(57) ABSTRACT

A remote camera control for a cell phone camera is extendably attached to a cell phone case to retract into and be held in the cell phone case when not in use and to be extended from the cell phone case when in use to also serve as a handle for holding the cell phone case and cell phone therein a distance away from the user for taking “selfies” or other pictures.

### PRIORITY CLAIM

Priority is claimed to copending U.S. Provisional Patent Application Serial No. 62/146,863 filed Apr. 13, 2015, which is hereby incorporated herein by reference in its entirety.

### BACKGROUND

### Field of the Invention

The present invention relates to cell phones with cameras therein, and to shutter controls and cases for such cell phones.

### State of the Art

There are many types of cases currently available and in use for cell phones. Most of these cases are of a plastic material and stretch to tightly cover the sides and back of the phone to protect the phone during transportation and use. There are also a number of more substantial cases that provide additional impact protection to the phone, such as if the phone is dropped, and provide a holster for the phone that clips to an article of the user's clothing, such as a belt. These cases all are open across the front of the phone to allow full access to the face (screen) of the phone in order for a user to operate the phone. Many cell phones today have cameras therein to take photographs and the cases designed for these cell phones with cameras include openings for the camera lenses through which the camera can take pictures. The camera shutter control is normally on the screen of the camera available to the user to operate by touching the camera logo on the screen to take a picture while the user is holding and aiming the lens of the cell phone camera. It has become very popular to use cell phone cameras to take “selfies”, i.e., pictures of oneself, while holding the cell phone and aiming the camera lens toward oneself. However, when holding the cell phone aimed at oneself, it is difficult to hold the cell phone far enough away from oneself to get more than the users face into the picture. It can also be difficult to operate the shutter control on the face of the phone when holding the phone in position for a “selfie”.

Published U.S. Patent Application 2014/0124521 says that “A common problem when using a cell phone, tablet, or other portable electronic device to take pictures, video, play games, and the like, is the inability of the user to firmly grip the phone. Many devices are touch-screens, or otherwise have large screens, that make them impractical for gripping. Even when a device can be gripped, this often blocks the camera lens, creating unwanted pictures and video. The inability to properly grip the device leads to a higher risk of the device falling and breaking, or being stolen from one's hands when in use.” The invention of Published U.S. Patent Application 2014/0124521 provides a protective case with at least one retractable handle and a means for extending and retracting the handle. “When a user desires to have a better grip on the electronic device 106, such as a cell phone, a user extends the handle 102 by pulling outward on pull-tab 104. The user may then grip handle 102 to better secure the electronic device from the risk of damage or theft, or to aid the user in holding the device better for game-play or other uses,” The retractable handle of the device of the Published U.S. Patent Application 2014/0124521 is a rigid loop that fits into the case and can be pulled out to an extended position to form the handle. When pulled out, the handle extends a distance less than the width of the device if to be held in a horizontal orientation or less than the length of the device if held in a vertical orientation. This short handle is provided for holding the cell phone or other electronic device. Functions of the phone are still controlled by the touch screen or buttons on the phone itself. Further, such handle will not position the cell phone farther away from a user taking a selfie than merely holding the cell phone itself without the handle.

Published U.S. Patent Application 2014/0184829 shows a photographing device, such as a cell phone, wherein the shutter control can be operated by a remote blue tooth controller. The phone is placed in a position away from the user and the camera lens aimed toward the expected position of the user. The user can then move to a position in front of the camera lens and remotely take the picture by operating the blue tooth remote controller, The Application says that “You can also take a selfie from a distance more than ten meters or longer by remotely controlling the digital camera, with easy operation, safe and reliable control, and good applicability.” Published U.S. Patent Application 2007/0254640 shows a pair of cell phones linked through blue tooth communication wherein one cell phone is positioned to take a picture and is then controlled remotely by the other cell phone to take the picture and wherein the other cell phone remotely shows the picture to be taken by, i.e., acts as the viewfinder for, the remotely placed cell phone. However, in both of these situations, the remotely controlled cell phone has to be positioned in the remote location and correctly directed for the desired picture before being remotely controlled to take the picture.

Published U.S. Patent Applications 2012/0195585 and 2014/0209777 both show mounting assemblies for mounting and holding cell phones wherein the mounting assemblies are adapted to be secured to a supporting structure such as a tripod or monopod which then supports and positions the cell phone in a desired location for taking a picture. There are also several commercially available monopods, such as the Minisuit Selfie Stick Pro shown at http://www.walmart.com/ip/Minisuit-Selfie-Stick-Pro-with-Built-In-Remote-on-Handle-for-GoPro-Apple-Android-Phones/40506535 (Dec. 5, 2014), which provide a telescoping monopod which can be extended up to three and one half feet and has a remote Bluetooth shutter control on the monopod handle allowing a user to operate the camera shutter to take pictures with a cell phone mounted to the end of the monopod. All of these require a mounting assembly for the cell phone and a separate monopod or tripod to which the cell phone can be mounted. The tripods and monopods, being separate items, must be carried separately from the cell phone to be attached to the cell phone through a cell phone mounting assembly when desired to be used. Carrying such separate items is inconvenient and unless planned for in advance, such separate items will not be available when they may be desired. Further, attachment of the mounting assembly to the phone and mounting the phone to the tripod or monopod takes time and effort.

There remains a need for a convenient way to quickly and easily position and hold a cell phone for taking a picture, particularly a “settle”, with the cell phone held at a distance from the user sufficient to include more than just the face of the user, and to remotely actuate the shutter control for the camera in the phone to take the picture.

### SUMMARY OF THE INVENTION

According to the invention, a remote camera control for controlling a cell phone camera is extendably attached to a cell phone case body to retract into and be held in the cell phone case body when not in use and to he extended from the cell phone case body when in use to also serve as a handle for holding the cell phone case body and cell phone therein a distance away from the user for taking “selfies”. The remote camera control of the invention may include a currently available Bluetooth cell phone remote camera control having a button that remotely activates the cell phone camera to take a picture when the button is pushed. With the current invention, this Bluetooth cell phone remote camera control is mounted to an extendable camera control extension arm which attaches to a cell phone case body and is retractable, along with the remote camera control, into the cell phone case body to be stored out of the way until it is needed for holding and controlling the cell phone when a photograph is to be taken. When retracted into the cell phone case body, the cell phone case is easily stored and carried as are existing cell phone cases with cell phones therein. The cell phone is easily accessed and used in normal manner while in the case. However, with the cell phone case and remote camera control of the invention, the remote camera control is always quickly available for use without assembly by merely extending it from the cell phone case body, and, when attached to the cell phone case body with the extendable camera control extension arm, remains connected to the cell phone case body so cannot be lost.

In one embodiment of the invention, the extendable camera control extension arm includes two telescoping tubes each having one end attached to the remote camera control and the opposite end attached to the cell phone case body. The telescoping tubes can be adjustably extended to hold the remote camera control at a desired distance from the cell phone case body up to the maximum extension of the tubes. The cell phone case body may be mounted to the tubes so it can be adjustably angled with respect to the tubes and the remote camera control.

In one embodiment of the invention, the cell phone case includes a one piece cell phone case body configured to receive and hold the cell phone in one side of the cell phone case body and to receive and hold the remote camera control and the extendable camera control extension arm in the other side of the cell phone case body. However, there are a variety of cell phones currently commercially available with many of the currently available cell phones having their own particular unique dimensions and requiring a cell phone case sized to fit that particular cell phone. In addition, it is common practice when a new model of a cell phone is released, that that new model has its own different dimensions. With the one piece cell phone case body embodiment of the invention, a different cell phone case body is required for each of the differently dimensioned cell phones.

In a second embodiment of the invention, the cell phone case body includes a cell phone case body base portion holding the remote camera control and the extendable camera control extension arm, and a phone wrap portion attached to the cell phone case body base portion, sized to receive and hold a particular cell phone. With the second embodiment of the cell phone case of the invention, the same cell phone case body base portion can be used for a variety of differently dimensioned cell phones with a different phone wrap portion attached to the cell phone case body base portion sized for the particular phone to be housed in the case. In addition, in the second embodiment, the phone wrap portion can be rotatable attached to the cell phone case body base portion to enable a user to rotate the phone wrap portion with respect to the cell phone case body base portion to adjust the position of the cell phone wrap with cell phone therein with respect to the cell phone case body base portion and the remote camera control and extendable camera control extension arm. For example, in one embodiment of the second embodiment, the phone wrap portion can be attached to be rotated up to ninety degrees with respect to the cell phone case body base portion to allow adjustment of the position of the cell phone with respect to the cell phone case body base portion for the cell phone to take photographs in portrait orientation or in landscape orientation.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a front elevation of a cell phone case according to the invention with a cell phone received in the cell phone case.

FIG. 2 is a rear view of the cell phone case of FIG. 1.

FIG. 3 is a right side elevation of the cell phone case of FIG. 1.

FIG. 4 is a pictorial rear view of the cell phone case of FIGS. 1-3 with the remote camera control removed from the case and attached to the case by the extendable camera control extension arm.

FIG. 5 is a pictorial front view of the cell phone case of FIG. 1-3 with the remote camera control removed from the case and attached to the case by the extendable camera control extension arm.

FIG. 6 is a front elevation of the remote camera control of FIGS. 4 and 5.

FIG. 7 is a top plan view of the remote camera control of FIG. 6.

FIG. 8 is a front elevation of the remote camera control of FIG. 6 drawn to a smaller scale and showing the telescoping tubes of the extendable camera control extension arm in contracted condition on the sides of the remote camera control.

FIG. 9 is a front elevation similar to that of FIG. 8 but showing the telescoping tubes of the extendable camera control extension arm in extended condition.

FIG. 10 is a pictorial view of the cell phone case of FIG. 1 with the cell phone removed.

FIG. 11 is a vertical section taken on the line 11-11 of FIG. 1.

FIG. 12 is a vertical section taken on the line 12-12 of FIG. 3.

FIG. 13 is an enlarged drawing of the encircled portion of FIG. 12.

FIG. 14 is a bottom view of the cell phone case shown in FIGS. 1 and 12.

FIG. 15 is a transverse section taken on the line 15-15 of FIG. 1.

FIG. 16 is a rear view of the cell phone case body of FIG. 2 with the remote camera control removed from the cell phone case body, with the telescoping tubes of the extendable camera control extension arm partially extended and extending from the cell phone case body, and with the remote camera control attached to the extended ends of the telescoping tubes.

FIG. 17 is a front view of the cell phone case of FIG. 16.

FIG. 18 is a side view of the cell phone case of FIGS. 16 and 17.

FIG. 19 is a horizontal section taken on the line 19-19 of FIG. 18.

FIG. 20 is a side view showing the cell phone case tilted with respect to the extendable camera control extension arm.

FIG. 21 is a vertical section through a cell phone case similar to FIG. 19 with remote camera control extended from the case and with the extendable camera control extension arm in condition to be disconnected from the case.

FIG. 22 is a front elevation of a second embodiment of a cell phone case according to the invention with a cell phone received in the cell phone case.

FIG. 23 is a left side elevation of the cell phone case of FIG. 22.

FIG. 24 is a rear view of the cell phone case of FIG. 22.

FIG. 25 is a pictorial view of the cell phone holding portion of the cell phone case of FIGS. 22-24.

FIG. 26 is a pictorial front view of the cell phone case of FIG. 22-24 with the remote camera control removed from the case and attached to the case by the extendable camera control extension arm.

FIG. 27 is a pictorial front view similar to that of FIG. 26, but showing the cell phone holding portion rotated ninety degrees with respect to the cell phone case body base portion.

FIG. 28 is an elevation of the front side of the cell phone case body base portion of the cell phone case of FIGS. 22-24 when the front phone wrap portion is separated from the cell phone case body base portion.

FIG. 29 is an exploded view of the cell phone case body base portion of FIG. 28.

FIG. 30 is a perspective view of a remote camera control usable with the cell phone case embodiment of FIGS. 22-24.

FIG. 31 is a perspective view of a telescoping tube assembly usable with the cell phone case embodiment of FIGS. 22-24.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

The invention provides a remote camera control for a cell phone camera and includes a cell phone case body which houses the cell phone with the camera and also houses the remote camera control. The remote camera control is mounted to the cell phone case body with an extendable camera control extension arm so that the remote camera control can be extended from the cell phone case body when it is desired to take a picture, particularly a “selfie”. In this manner, the camera can be better positioned away from the user to take a “selfie” and the “selfie” can be easily taken using the remote camera control without the user having to strain to reach the camera control on the cell phone itself when taking the “selfie”. The remote camera control also provides a handle for holding the cell phone case body with camera therein away from the user and is adjustable to adjust the distance of the camera from the user up to a maximum extension distance and to adjust the orientation of the camera with respect to the handle and the user. The cell phone case of the invention holds the cell phone in normal cell phone case manner so is easily carried by a user allowing normal use of the cell phone when in the cell phone case. When it is desired to take a “selfie”, the remote camera control is immediately available to be extended from the cell phone case body while remaining attached to the cell phone case body by the extendable camera control extension arm so that the camera can be easily positioned and operated to take the “selfie”. Since all components are carried by the cell phone case body, they are immediately available and ready to be used without requiring any carrying of and assembly of separate parts. In addition, there are no separate parts to be lost.

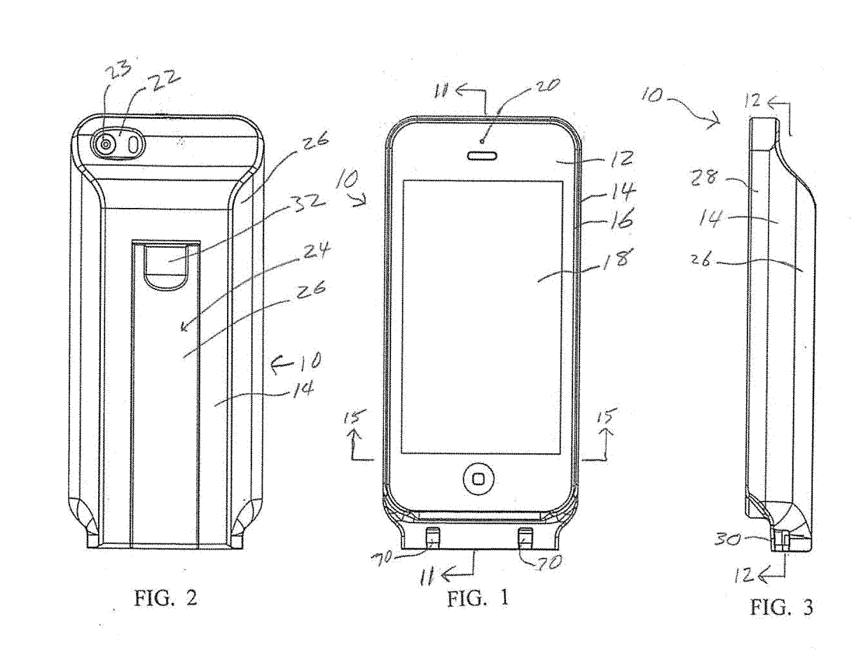

FIG. 1 shows an embodiment of a cell phone case of the invention, generally indicated as 10, housing a cell phone 12 in a one piece cell phone case body 14 in normal cell phone case manner. Cell phone case body edges 16 fit over the edges of the cell phone to hold cell phone 12 in cell phone case body 14 with the cell phone screen 18 unobstructed to allow normal use of the cell phone. This also allows use of a forward facing camera lens 20, if such a forward facing lens is included in the cell phone 12 held in the cell phone case 10. Such forward facing camera lenses are available with most of the currently available cell phones.

FIG. 2 shows the back of the cell phone case 10 which includes a lens opening 22 through the cell phone case body 14 for the traditional cell phone camera lens 23 in the back of the cell phone, which is aligned with the lens opening 22 when the cell phone 12 is received in the cell phone case 10. A remote camera control, generally 24, is removably received in a cell phone case body back portion 26 of cell phone case body 14. In the illustrated embodiment, cell phone case body back portion 26 of cell phone case body 14 extends rearwardly of a cell phone case body front portion 28 of the cell phone case body which receives and holds the cell phone 12 in normal cell phone case manner, but increases the thickness of the cell phone case 10 of the invention over the thickness of most currently available cell phone cases, see FIG. 3. However, this increase in thickness of the cell phone case 10 has not been found to interfere with the normal use of the cell phone 12 in the case or the convenience of use of the cell phone case 10 over the currently available narrower cell phone cases. In addition, cell phone case body back portion 26 of cell phone case body 14 extends below the bottom edge of the cell phone case body front portion 28 of the cell phone case body 14 to form a case lower flange 30. With the remote camera control 24 received in back portion 26 of cell phone case body 14, the cell phone case 10 is carried in normal manner and the cell phone 12 held in cell phone case 10 is operated in normal manner. This includes being able to take pictures (photographs) with the cell phone 12 in normal manner using the cell phone camera controls normally provided on the unobstructed cell phone screen 18.

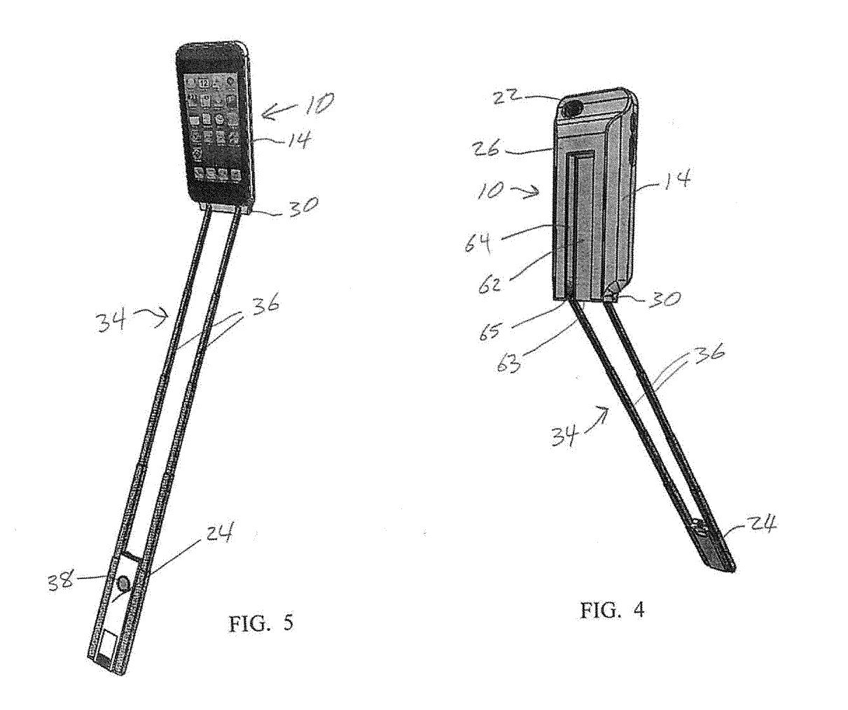

When it is desired to take a picture using the camera in the cell phone 12 held in cell phone case body 14 at a distance from the user, such as when taking a selfie or when holding the cell phone above a crowd, the user slides the remote camera control 24 out of the cell phone case body 14, such as by placing a thumb or finger in the finger hold 32 to apply sliding force, and pulls the remote camera control 24 out of the cell phone case body 14 and away from the cell phone case body 14, FIGS. 4 and 5, a desired distance to extend an extendable camera control extension arm 34, which, in the illustrated embodiment, includes two telescoping tubes 36, which extend through cell phone case body lower flange 30 and which attach the remote camera control 24 to the cell phone case body 14. Initially, in the illustrated embodiment, the remote camera control 24 is pulled outwardly in line with the cell phone case body 14 until the ends of the telescoping tubes 36 reach the inside of the cell phone case body lower flange 30. The ends of the telescoping tubes 36 where attached to the cell phone case body in case lower flange 30 can be made rotatable through a range of rotation so that the cell phone case body 14 can be rotated with respect to the telescoping tubes, such as shown in FIGS. 4 and 5, to a desired orientation. FIGS. 4 and 5 show the cell phone case body 14 and cell phone 12 therein rotated with respect to the telescoping tubes 36 and the remote camera control 24 so that the cell phone screen 18 is facing the user holding the remote camera control 24. In this orientation, for taking “selfies”, the forward facing camera lens 20 directed from the front (screen side) of the cell phone is used. Other pictures can be taken using the rearward facing lens through lens opening 22, and depending upon the eyes of the user and lighting conditions, the picture to be taken can be viewed on the phone screen which acts as the viewfinder for the camera.

FIGS. 4 and 5 show the remote camera control 24 removed from the cell phone case body 14 and extended from the cell phone case body 14 to the full extension of extendable camera control extension arm 34. FIGS. 4 and 5 show the two telescoping tubes 36 each with five telescoping sections, and with each tube extended to its full extension. In order to fit within the cell phone case body 14 when collapsed, each of the sections of the telescoping tubes 36 must be shorter than the length of the cell phone case body. Thus, when the five sections are fully extended, as shown, the remote camera control 24 is spaced about three to four case body lengths from the case body. This represents the maximum distance when using five telescoping sections that the cell phone camera can be spaced from the remote camera control 24 with the remote camera control 24 still attached to the cell phone case body 14, whereby the remote camera control 24 can he used as a handle to hold and manipulate the cell phone case body 14 and the cell phone with camera therein. With current sized cell phones, and using five telescoping sections for telescoping tubes 36, the telescoping tubes 36 can be extended to a total length of about 440 mm or about 17 inches.

The ends of the telescoping tubes 36 where attached to the cell phone case body 14 can be made to he disconnected which will allow the phone to be spaced further from the user on an independent support and still be remotely operated by use of the remote camera control 24 separated from the cell phone case 10. However, it has been found that the distance provided by the telescoping tubes 36 as shown is sufficient for most “selfies”. For lesser separation, the telescoping tubes 36 can be partially extended to any desired intermediate length. Telescoping tubes 36 may be rectangular, such as square, in cross section rather than round to prevent rotation of the respective telescoping sections with respect to one another. This can make adjusting the angle of the cell phone case 10 with respect to the remote camera control 24 easier and more stable. In addition, such telescoping tube sections can be made of various materials, such as carbon fiber material or metal. Carbon fiber material works well when using square tubes. Tube diameters of about 4 mm (about 0.157 inch) for the smallest square tube and about 8 mm (about 0.3 inch) for the largest square tube has been found satisfactory when using five telescoping sections.

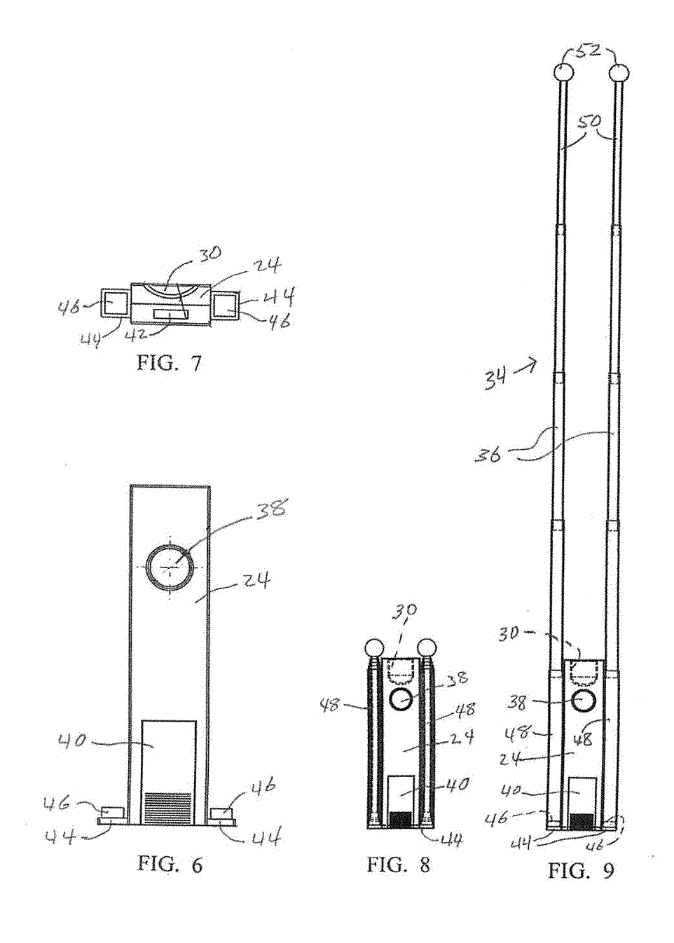

FIGS. 6-9 show details of the remote camera control 24, the two telescoping tubes 36 of the extendable camera control extension arm 34, and the attachment of the telescoping tubes 36 to the remote camera control 24. As shown, the remote camera control 24 includes a camera control button 38, a battery receiving space with battery cover 40, an on-off switch 42, FIG. 7, and extendable camera control extension arm attachment tabs 44. The extendable camera control extension arm attachment tabs 44 extend outwardly from the end of the remote camera control 24 that will be away from the cell phone case body 14 when assembled and include tube inserts 46 to be received into the camera control ends 48, FIG. 9, of the telescoping tubes 36. The camera control ends 48 of the telescoping tubes 36 are generally the largest diameter sections of the telescoping tubes 36. When attached to the remote camera control 24, these largest diameter sections of the telescoping tubes 36 extend along opposite side edges of the remote camera control 24. The camera control ends 48 of the telescoping tubes 36 are usually nonremovably (permanently) attached to the remote camera control 24. For example, the camera control ends 48 of the telescoping tube 36 (the largest diameter section of each of the telescoping tubes 36) may be adhered to the remote camera control 24 along opposite side edges of the remote camera control 24. The opposite ends of the telescoping tubes 36, i.e., the case body attachment ends 50 of the telescoping tubes 36, may have balls 52 at their ends. These balls 52 may be attached to the case body attachment ends 50 of the telescoping tubes 36, such as by adhesives, or, depending upon the material from which the telescoping tubes are made, may be welded to the ends of the case body attachment ends 50 of the telescoping tubes 36 or may be molded on the case body attachment ends 50 of the telescoping tubes 36. The case body attachment ends 50 of the telescoping tubes 36 are generally the smallest diameter sections of the telescoping tubes 36.

Systems for remotely controlling operation of a cell phone camera are currently known, and such systems using Bluetooth technology are commercially available. Such currently available systems can be packaged in a satisfactory package, such as the rectangular package as illustrated for the remote camera control 24, for use in the current invention. The illustrated camera control button 38 is a button that operates such a prior art remote control system to remotely operate the camera in the cell phone. Depressing camera control button 38 will operate the camera to take a picture.

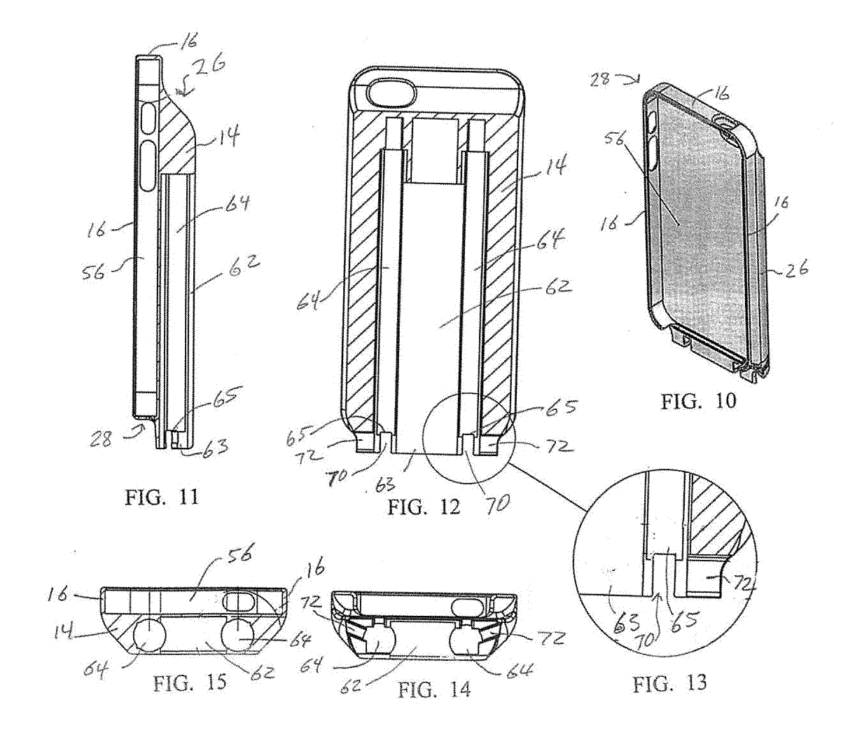

FIG. 10 is a pictorial view of the front of the cell phone case body 14 without a cell phone received therein, FIG. 10 shows the cell phone receiving space 56 formed by cell phone case body edges 16 in the case front portion 28. This cell phone receiving space 56 receives and holds the cell phone 12, FIG. 1, in the case in normal manner for most cell phone cases. The cell phone case body edges 16 are stretched as the cell phone is inserted into cell phone receiving space 56 and the cell phone 12 is securely held in cell phone receiving space 56 once inserted. This is similar to most currently available cell phone cases. This cell phone receiving space 56 is also shown in the section of FIG. 11, which is taken on the line 11-11 of FIG. 1. FIG. 12 is a sectional view taken on the line 12-12 of FIG. 3, FIGS. 11 and 12 show the remote camera control receiving space 62 in case back portion 26 and telescoping tube receiving channels 64 along the sides of the remote camera control receiving space 62. Remote camera control receiving space 62 in cell phone case body 14 is open at the back of the phone case body 14 as shown in FIGS. 4, 11, 12, 14, and 15, FIG. 14 being a bottom elevation of the cell phone case body of FIG. 1 and FIG. 15 being a transverse sectional view taken on the line 15-15 of FIG. 1, but without the cell phone in the case. Both the remote camera control receiving space 62 and the telescoping tube receiving channels 64 open through the bottom of cell phone case body 14 as shown by reference numbers 63 and 65 respectively, in FIGS. 4 and 11-13. When the assembly of the remote camera control 24 and telescoping tubes 36 are assembled into phone case body 14, the telescoping tubes 36 are received and slide in the telescoping tube receiving channels 64 extending from and along the sides of the remote camera control receiving space 62 as the remote camera control 24 slides into the remote camera control receiving space 62. This then produces the assembly shown in FIG. 2, which is the assembly carried around by and used by the user for general cell phone use. The remote camera control 24 and the extendable camera control extension arm 34 are complete held within and as part of the cell phone case 10. In this configuration, the remote camera control 24 and the extendable camera control extension arm 34 are maintained out of the way so as to not interfere with cell phone use, carrying, or storage, but ready for extension and use whenever a “selfie” or other photograph is desired to be taken. Also, the camera control button 38 is protectively housed within the cell phone case body 14.

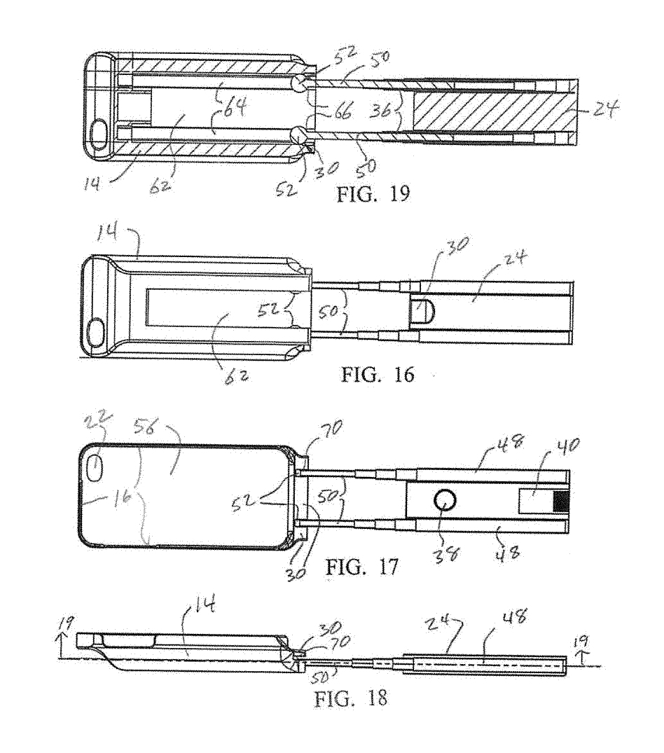

FIGS. 16-19 show the cell phone case body 14 with the remote camera control 24 removed from the remote camera control receiving space 62, the telescoping tubes 36 only partially extended, and the balls 52 at the case body attachment ends of the telescoping tubes 36 received at the open ends of the telescoping tube receiving channels 64 in case lower flange 30. These Figs. show the attachment of the telescoping tubes 36 to the cell phone case body 14.

When the assembly of the remote camera control 24 and telescoping tubes 36 are assembled into phone case body 14 as shown in FIGS. 1-3, when a “selfie” or other photograph is desired to be taken, the remote camera control 24 is slid out of cell phone case body 14 as previously described which also slides the telescoping tubes 36 along telescoping tube receiving channels 64 and extends telescoping tubes 36 as the remote camera control 24 is pulled away from the cell phone case 10. The balls 52 at the case body attachment ends of the telescoping tubes 36 will also slide along telescoping tube receiving channels 64 in cell phone case body 14. The ends 66 of telescoping tube receiving channels 64, FIG. 19, where they pass through the case lower flange 30 to allow the telescoping tubes 36 to extend from the cell phone case body 14, are sized to frictionally capture balls 52 within ends 66 of the telescoping tube receiving channels 64 to prevent them from passing through the ends 66 and separating from the cell phone case body 14. Case lower flange 30 includes slots 70 therein,

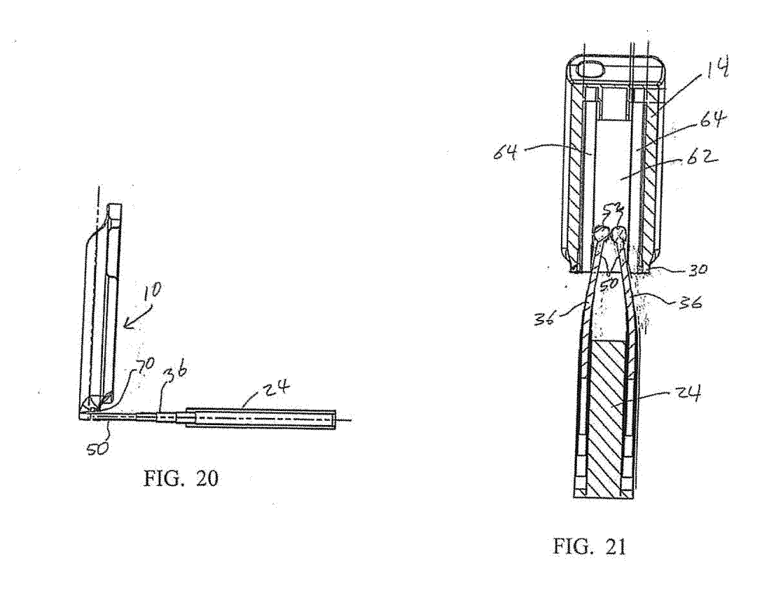

FIGS. 1, 12, 13, and 20, extending from the ends 66 of the telescoping tube receiving channels 64 through case lower flange 30 to the front of the case lower flange 30 to allow the case body attachment ends 50 of the telescoping tubes 36 to rotate upwardly in the slots, FIG. 20, as balls 52 rotate in ends 66 of telescoping tube receiving channels 64 where they pass through the case lower flange 30. This allows rotation of the telescoping tubes 36 and remote camera control 24 with respect to cell phone case body 14 to positions as shown in FIGS. 4, 5, and 20. Further, case lower flange 30 can include slots 72 therein extending from the ends 66 of the telescoping tube receiving channels 64 through case lower flange 30 to the sides of the case lower flange 30 as shown in FIGS. 12-14, to allow the case body attachment ends 50 of the telescoping tubes 36 to rotate upwardly in the slots as balls 52 rotate in ends 66 of telescoping tube receiving channels 64 where they pass through the case lower flange 30. These arrangements allow adjustment of the remote camera control 24 with respect to the cell phone case 10 while maintaining attachment of the remote camera control 24 to the cell phone case 10. After taking the desired photographs, the remote camera control 24 is moved to align it with the remote camera control receiving space 62 and the remote camera control 24 is pushed toward the case body 14 thereby causing the telescoping tubes 36 to telescope into one another and to push along telescoping tube receiving channels 64 as remote camera control 24 is pushed to the case body 14 and then into remote camera control receiving space 62.

In some cases, it may be desirable to completely separate the remote camera control 24 from the cell phone case 10, such as when it is desired to place the cell phone in a more distant location from the user when taking a picture. In such a case, the balls 52 at the tube case body attachment ends 50 of the telescoping tubes 36 can be pushed from the telescoping tube receiving channels 64 by pushing portions of telescoping tubes 36 outside the cell phone case body 14 to move the balls 52 into the remote camera control receiving space 62 of case body 14, FIG. 21, enough to move balls 52 toward one another into the open remote camera control receiving space 62 from where they can be removed from the remote camera control receiving space 62. In this way, the remote camera control 24 with telescoping tubes 36 attached thereto can be separated from the case body 14. Telescoping tubes 36 are somewhat resilient so can be bent sufficiently to move the balls 52 from the telescoping tube receiving channels 64 into the remote camera control receiving space 62. Rather than pushing both balls 52 toward one another into the remote camera control receiving space 62 as shown in FIG. 21, each ball 52 can be pushed separately into remote camera control receiving space 62 and removed to reduce the amount of bending of telescoping tubes 36. The removal procedure is reversed to again insert the balls 52 into the telescoping tube receiving channels 64 to reassemble the remote camera control to the case.

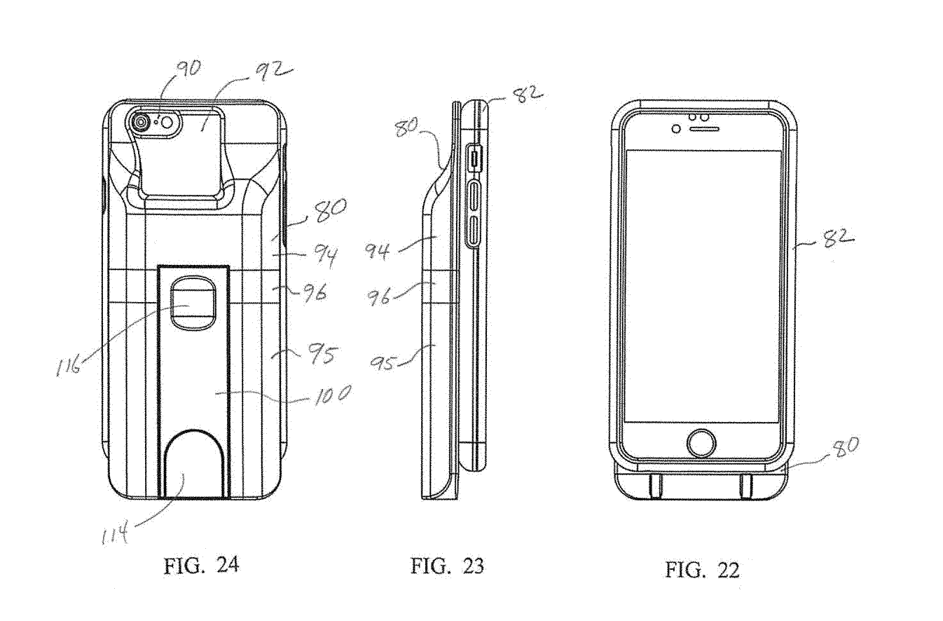

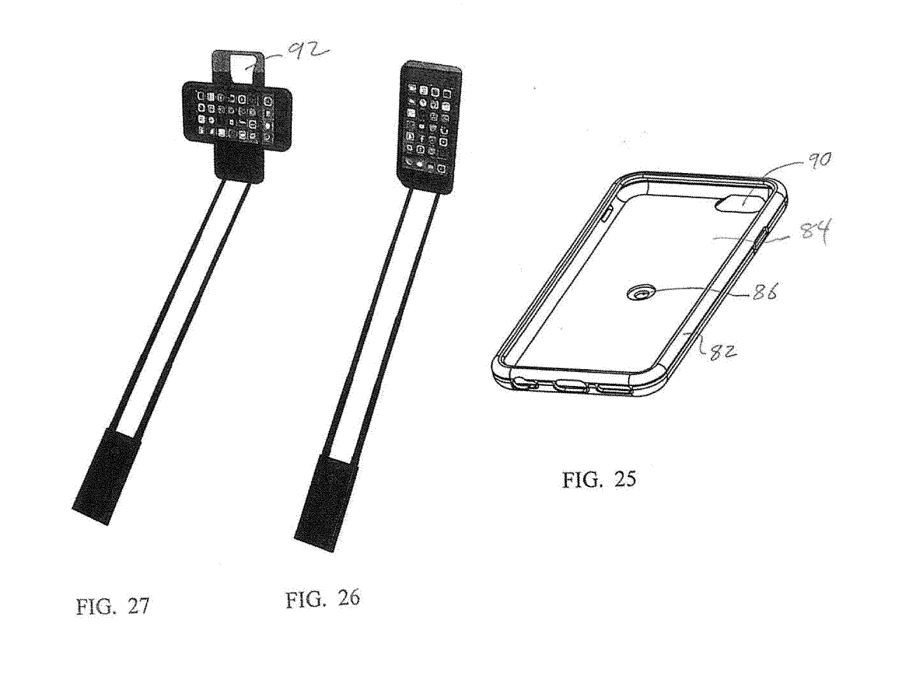

The illustrated embodiment described so far includes a one piece cell phone case body. With a one piece cell phone case body, the cell phone receiving space 56 is made a particular size and shape to fit a particular phone. A different one piece cell phone case body is required for each differently sized phone. FIGS. 22-24 show a two piece cell phone case body according to the invention which includes a cell phone case body base portion 80 holding the remote camera control and the extendable camera control extension arm, and a phone wrap portion 82 attached to the cell phone case body base portion, sized to receive and hold a particular cell phone. With this embodiment, the same cell phone case body base portion 80 can be used with a variety of different cell phones by changing the phone wrap portion 82 to one that fits a particular cell phone to he held by the cell phone case. FIG. 25 shows a separated phone wrap portion 82 without the cell phone therein which provides a cell phone receiving space 84, similar to cell phone receiving space 56 previously described, and sized to receive and hold a cell phone of particular dimensions. While phone wrap 82 can be secured in various ways to cell phone case body base portion 80, it is particularly advantageous to pivotally mount phone wrap 82 to cell phone case body base portion 80 so it can be rotated with respect to cell phone case body base portion 80. For this purpose, phone wrap portion 82 can include a mounting hole 86, FIG. 25, centrally located in phone wrap portion 82. A fastener can be passed through mounting hole 86 and into cell phone case body base portion 80 to pivotally mount phone wrap 82 to cell phone case body base portion 80. Such a pivot mounting is advantageous because it allows a user to rotate the phone wrap portion with respect to the cell phone case body base portion to adjust the position of the cell phone wrap with cell phone therein with respect to the cell phone case body base portion and the remote camera control and extendable camera control extension arm. For example, the phone wrap portion can be attached to be rotated up to ninety degrees with respect to the cell phone case body base portion. This allows the phone wrap to be moved by a user between an aligned position as shown in FIG. 26 which holds the cell phone in a portrait orientation for picture taking or rotated position as shown in FIG. 27 which holds the cell phone in a landscape orientation for picture taking.

Phone wrap 82 will include a camera lens opening 90, FIGS. 24 and 25, positioned to align with the back facing lens of the cell phone for which phone wrap 82 is sized to hold. Since cell phone case body base portion 80 is adapted to mount various phone wraps 82 holding different cell phones which may have the back facing camera lens in different locations and therefore have the camera lens opening 90 at different locations in phone wrap 82, the cell phone case body base portion 80 should have a much larger camera lens opening 92, FIGS. 24 and 27, so it will provide an opening for the hack facing camera lens for a variety of cell phone cameras,

In this second embodiment, cell phone case body base portion 80 is shown as assembled from an upper base piece 94, a lower base piece 95, and an intermediate joining base piece 96, FIGS. 23, 24, 28 and 29. A fastener passing through aligned holes 97 in the upper, intermediate, and lower base pieces (not visible in the lower base piece) can secure the upper, intermediate, and lower base pieces together. Intermediate joining piece 96 includes hole 98 to receive a mounting fastener passing through hole 86 in phone wrap 82 to pivotally mount phone wrap 82 to cell phone case body base portion 80. The four holes 99 around hole 98 can receive one or more resilient projections extending from the back side of phone wrap 82 to resist rotation of phone wrap 82 in relation to cell phone case body base portion 80 and tend to hold phone wrap 82 at ninety degree rotated positions.

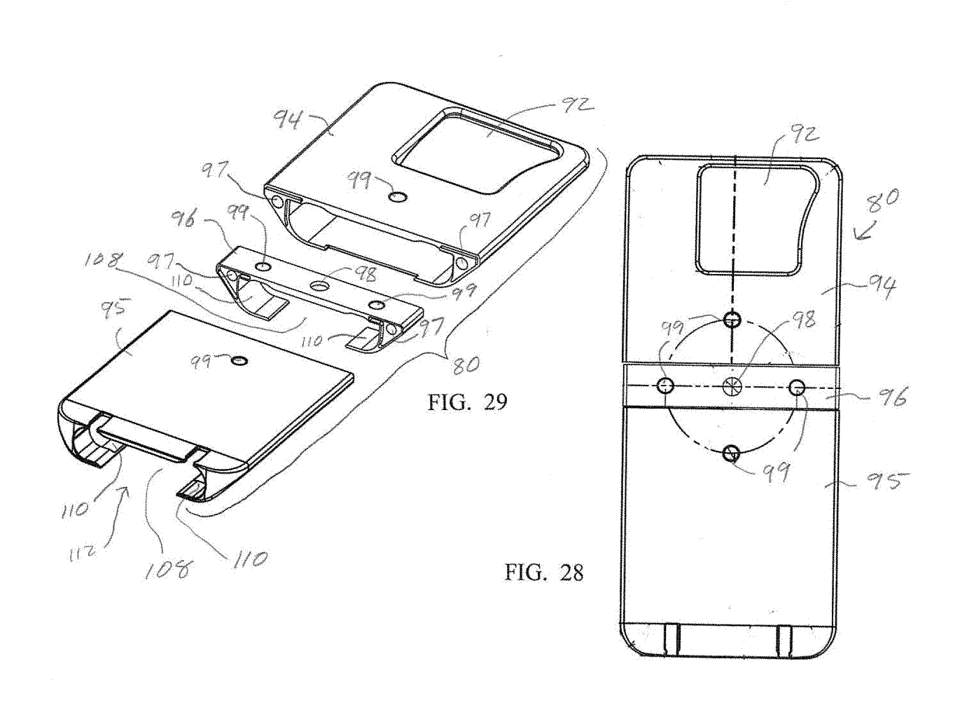

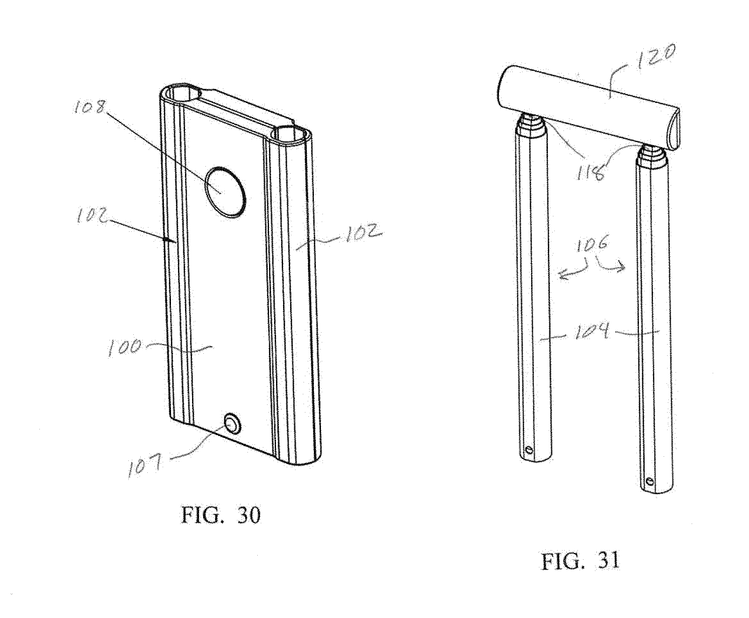

The remote camera control 100 of this embodiment is shown in FIG. 30 and includes cylindrical receiving openings 102 along opposite sides thereof for receiving the camera control ends 104 of the telescoping tubes 106, FIG. 31, therein. An on-off switch 107 controls power and camera control button 108 is pushed when a picture is to be taken by the camera. As seen in FIG. 29, cell phone case body base portion 80 includes remote camera controlreceiving space 108 and telescoping tube receiving channels 110 for receiving and holding remote camera control 100 as shown in FIG. 24. Remote camera control 100 as shown in Fig, 30 is slid into remote camera control receiving space 108 in cell phone case body base portion 80 and telescoping tube receiving channels 110 through bottom opening 112 thereof, FIG. 29. The back of remote camera control 100 includes battery receiving space cover 114, FIG. 24, and thumb or finger hold 116 to help a user remove remote camera control 100 when desired to remove it from its position in the remote camera control receiving space 108. Rather than balls on the ends of the case body attachment ends 118 of the telescoping tubes 106, FIG. 31 shows a solid bar 120 connecting the respective case body attachment ends of the telescoping tubes 106. This solid bar 120 is configured to fit through bottom opening 112 of cell phone case body base portion 80 and to slide along telescoping tube receiving channels 110. It has been found that the solid bar 120 can reduce twisting of the telescoping tubes 106 when in extended position.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A cell phone case with extendable remote camera control for holding a cell phone having a camera therein, said case having an opening through which the cell phone can take a photograph, and an extendable and retractable remote camera control adjustably attached to the case and forming a handle for the case when extended, comprising:
a cell phone case body having a cell phone receiving space adapted to receive and hold a cell phone therein, and a remote camera control receiving space adapted to removably receive a remote camera control;
a remote camera control for remotely controlling the cell phone camera remote from the cell phone; and
an extendable camera control extension arm having a case body attachment end adapted to attach the extendable camera control extension arm to the cell phone case body and a camera control end opposite the case body attachment end adapted to attach the extendable camera control extension arm to the remote camera control, said extendable camera control extension arm being extendable from a retracted condition when the remote camera control is received in the remote camera control receiving space and an extended condition when the remote camera control is removed from the remote camera control receiving space to thereby maintain the remote camera control attached to the cell phone case body.

2. A cell phone case with extendable remote camera control according to claim 1, wherein the remote camera control includes a user operable remote camera control transmitting circuit therein, a power supply therein, and the camera control end of the extendable camera control extension arm secured thereto.

3. A cell phone case with extendable remote camera control according to claim 2, wherein the extendable camera control extension arm includes two telescoping tubes each having a tube camera control end forming the camera control end of the extendable camera control extension arm and a tube case body attachment end forming the case body attachment end of the extendable camera control extension arm.

4. A cell phone case with extendable remote camera control according to claim 3, wherein the tube camera control ends of the two telescoping tubes are secured along opposite side edges of the remote camera control.

5. A cell phone case with extendable remote camera control according to claim 4, additionally including telescoping tube receiving channels along opposite sides of the remote camera control receiving space adapted to receive the telescoping tubes when the remote camera control is received in the remote camera control body receiving space.

6. A cell phone case with extendable remote camera control according to claim 5, wherein the remote camera control receiving space and the telescoping tube receiving channels open through an edge of the cell phone case body to allow the remote camera control to slide into and out of the remote camera control receiving space.

7. A cell phone case with extendable remote camera control according to claim 6, additionally including balls on the case body attachment ends of the telescoping tubes and ball receiving and holding spaces at the ends of the telescoping tube receiving channels where the telescoping tube receiving channels open through the edge of the cell phone case body, whereby the balls are captured in the ball receiving and holding spaces when the remote camera control body is slid from the remote camera control body receiving space.

8. A cell phone case with extendable remote camera control according to claim 7, wherein the balls can rotate through a range of rotation within the ball receiving and holding spaces to change the orientation of the telescoping tubes with respect to the cell phone case body.

9. A cell phone case with extendable remote camera control according to claim 8, wherein the telescoping tubes are square tubes so that the tubes cannot rotate with respect to one another.

10. A cell phone case with extendable remote camera control according to claim 1, wherein the cell phone case body includes a phone wrap portion forming the cell phone receiving space and a cell phone case body base portion forming the remote camera control receiving space.

11. A cell phone case with extendable remote camera control according to claim 10, wherein the phone wrap portion is a separate piece attached to the cell phone case body base portion.

12. A cell phone case with extendable remote camera control according to claim 11, wherein the phone wrap portion is pivotally attached to the cell phone case body base portion to allow the phone wrap portion to rotate with respect to the cell phone case body base portion.

13. A cell phone case with extendable remote camera control according to claim 11, wherein the phone wrap portion is removably attached to the cell phone case body base portion to allow the phone wrap portion to be removed from the cell phone case body base portion and replaced with a replacement phone wrap portion.
